(19) United States
(12) Patent Application Publication
(10) Pub. No.: US 2015/0202026 A1
(43) Pub. Date: Jul. 23, 2015

(54) Orthodontic Bracket With Locking Shutter Extension

(71) Applicant: Orthoarm, Inc., Toronto (CA)

(72) Inventor: John Voudouris, Toronto (CA)

(21) Appl. No.: 14/421,029

(22) PCT Filed: Aug. 16, 2013
(86) PCT No.: PCT/CA2013/050635

§ 371 Date: Feb. 11, 2015

Related U.S. Application Data
(60) Provisional application No. 61/683,927, filed on Aug. 16, 2012.

(51) Int. Cl. A61C 7/28

(52) U.S. Cl. CPC A61C 7/28

(57) ABSTRACT

An orthodontic bracket including a body including a bonding base for attachment to a tooth, at least one gingival tie wing and at least one occlusal tie wing; the at least one gingival tie wing and the at least one occlusal tie wing projecting from a labial surface of the body; an archwire slot extending mesiodistally across the body and between the at least one gingival and occlusal tie wings at opposed mesial and distal sides of the body to accommodate an archwire; and a locking shutter moveable between an open position in which placement and removal of the archwire is facilitated and a closed position in which placement and removal of the archwire is inhibited. The locking shutter includes a main shutter portion which substantially covers the archwire slot when the locking shutter is in the closed position and an extension member extending beyond an outer edge of the body to contact a portion of the archwire outside of the archwire slot.

### RELATED APPLICATIONS

This application claims priority to U.S. Provisional Application No. 61/683,927 filed Aug. 16, 2012; the contents of all of which are herein expressly incorporated by reference.

### FIELD OF THE INVENTION

The present invention relates to the field of orthodontics, and more particularly to orthodontic brackets having locking shutter extensions and/or archwire slot extensions.

### BACKGROUND OF THE INVENTION

As is known, orthodontic treatment is effected by fixing small appliances called orthodontic brackets to a patient's teeth. Namely, the orthodontic brackets are most commonly used by being fixed to the patient's teeth in an appropriate manner so as to correct the misaligned teeth by applying an external force thereto through an arch wire extending between the fixed orthodontic brackets. As to the structure of these orthodontic brackets, they are constructed of a body having small slots and are adhered directly on the labial or lingual sides of the teeth or welded to such as metal bands attached to the teeth by cementing or by some other method.

As these orthodontic brackets head towards miniaturization, the movement of teeth and particularly due to sliding, and the movement of the bracket itself along an archwire can often cause the bracket to rotate labially-lingually (from the lip to the tongue side) with respect to the archwire. This type of rotation is undesirable as it leads to a loss of efficiency in the orthodontic treatment. In addition, this issue can arise with standard sized brackets as well. While it is sometimes possible to vary the treatment to avoid this type of rotation, this is not a desirable solution as it can lead to an increase in treatment time.

Accordingly, there is a need in the art for an orthodontic bracket having features that counter rotation of the bracket as mentioned above. Furthermore, there is a need for an orthodontic bracket that addresses one or more of the aforementioned problems with the prior art.

### SUMMARY OF THE INVENTION

According to one embodiment of the invention, there is provided an orthodontic bracket including a body including a bonding base for attachment to a tooth, at least one gingival tie wing and at least one occlusal tie wing; the at least one gingival tie wing and the at least one occlusal tie wing projecting from a labial surface of the body; an archwire slot extending mesiodistally across the body and between the at least one gingival and occlusal tie wings at opposed mesial and distal sides of the body to accommodate an archwire; a locking shutter moveable between an open position in which placement and removal of the archwire is facilitated and a closed position in which placement and removal of the archwire is inhibited; wherein the locking shutter includes a main shutter portion which substantially covers the archwire slot when the locking shutter is in the closed position and an extension member extending beyond an outer edge of the body to contact a portion of the archwire outside of the archwire slot.

According to one aspect of the invention, the at least one gingival tie wing comprises a pair of gingival tie wings, and the at least one occlusal tie wing comprises a pair of occlusal tie wings.

According to another aspect of the invention, the extension member projects beyond an outer edge of the body in a direction generally parallel with an underside of the bonding base.

According to another aspect of the invention, the extension member further includes a curved portion.

According to another aspect of the invention, the curved portion extends towards the archwire to thereby contact the archwire.

According to another aspect of the invention, the main shutter portion extends into a locking shutter recess formed on an underside of the pair of gingival tie wings.

According to another aspect of the invention, there is further provided an archwire guide adapted to support the archwire at a region distal from the archwire slot.

According to another aspect of the invention, the archwire guide forms an extension of a bottom surface of the archwire slot.

According to another aspect of the invention, the archwire guide is formed from a semi-rigid or flexible material.

According to another aspect of the invention, the archwire guide extends to a position beyond the an outer edge of the bonding base on one or both of the mesial and distal sides of the bracket.

According to a second embodiment of the invention, there is provided an orthodontic bracket including a body including a bonding base for attachment to a tooth, at least one gingival tie wing and at least one occlusal tie wing; the at least one gingival tie wing and the at least one occlusal tie wing projecting from a labial surface of the body; an archwire slot extending mesiodistally across the body and between the at least one gingival and occlusal tie wings at opposed mesial and distal sides of the body to accommodate all archwire; a locking shutter moveable between an open position in which placement and removal of the archwire is facilitated and a closed position in which placement and removal of the archwire is inhibited; and, an archwire guide adapted to support the archwire; at a region distal from the archwire slot.

According to one aspect of the second embodiment, the archwire guide forms an extension of a bottom surface of the archwire slot.

According to another aspect of the invention, the archwire guide is formed from a semi-rigid or flexible material.

According to another aspect of the invention, the archwire guide extends to a position beyond an outer edge of the bonding base on one or both of the mesial and distal sides of the bracket.

According to another aspect of the invention, the locking shutter includes a main shutter portion which substantially covers the archwire slot when the locking shutter is in the closed position and an extension member extending beyond an outer edge of the body to contact a portion of the archwire outside of the archwire slot.

According to another aspect of the invention, the at least one gingival tie wing comprises a pair of gingival tie wings, and the at least one occlusal tie wing comprises a pair of occlusal tie wings.

According to another aspect of the invention, the extension member projects beyond an outer edge of the body in a direction generally parallel with an underside of the bonding base.

According to another aspect of the invention, the extension member further includes a curved portion.

According to another aspect of the invention, the curved portion extends towards the archwire to thereby contact the archwire.

According to another aspect of the invention, the main shutter portion extends into a locking shutter slot formed on an underside of the pair of gingival tie wings.

### BRIEF DESCRIPTION OF THE DRAWINGS

The novel features which are believed to be characteristic of the present invention, as to its structure, organization, use and method of operation, together with further objectives and advantages thereof, will be better understood nom the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective of an orthodontic bracket according to one embodiment of the invention.

FIG. 2 is a front view of the embodiment of FIG. 1.

FIG. 3 is a perspective of an orthodontic bracket according to a second embodiment of the invention.

FIG. 4 is a front view of the embodiment of FIG. 3.

FIGS. 5 and 6 schematically illustrate the rotational movement of the orthodontic bracket during treatment.

### DETAILED DESCRIPTION

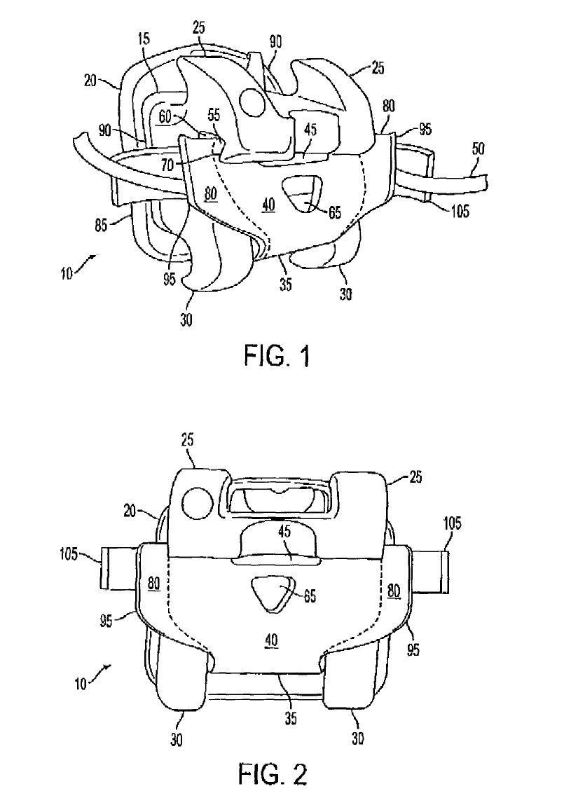

The invention as herein described is applicable to a variety of types of self-ligating orthodontic brackets, and the teachings of the invention will readily be adapted to various implementations of such self-ligating orthodontic brackets. In order to illustrate the invention and show several working examples, various embodiments are described with respect to a typical structure of an orthodontic bracket. With reference to FIG. 1, there is shown a bracket 10 including a body 15 having a bonding base 20 for attachment to a tooth. The base 20 includes a pair of laterally spaced gingival tie wings 25, and a pair of laterally spaced occlusal tie wings 30. The gingival 25 and occlusal tie wings 30 project from a labial surface of the body 15, with the occlusal tie wings 30 adapted to receive one or more arm members 35 of a locking shutter 40 through the spacing between the occlusal tie wings 30. An archwire slot 45 is provided extending mesiodistally across the body and between the gingival 25 and occlusal 30 tie wings at opposed mesial and distal sides of the body to accommodate au archwire 50. The locking shutter 40 is moveable between an open position in which placement and removal of the archwire 50 is facilitated and a closed position in which placement and removal of the archwire 50 is inhibited. In the closed position, a retaining portion 55 of the locking shutter 40 is friction fit into a retaining groove 60 formed adjacent to the archwire slot 45, in each of the gingival tie wings 25. During normal use, when the locking shutter 40 is in the closed position, the archwire 50 is pressed into, and seated entirely within the archwire slot 45.

An exemplary locking shutter 40 may be formed of a resilient stainless steel, and is pivotally mounted on the occlusal tie wings 30, moveable between open and closed positions as described above. One end of the locking shutter 40 may pass through an undercut in the body 20 and extended through the body to maintain the locking shutter in place. Alternatively, one end of the locking shutter 40 may be accommodated by undercuts (not shown) defined by the occlusal tie wings 30. This end of the locking shutter 40 accommodated by the undercuts generally resembles an open “D” and is configured to remain in the undercuts throughout movement of the shutter between the open and closed position. As the shutter moves between the open and closed positions, the end 30a translates within the undercuts 34. An aperture 65 may be formed in the locking shutter 40 to accommodate a tool to facilitate opening of the locking shutter 40. A general description of a prior art locking shutter functioning in this manner may be found in U.S. Pat. No. 5,857,850 to Voudouris (the inventor of the present invention).

The locking shutter 40 curves labially and ginigvally between the occlusal tie wings 30 and then curves lingually towards the archwire slot 45. When the shutter 40 is in the closed position and the archwire applies a labially directed force to the shutter 40, the gingival end of the locking shutter 40 may contact deflection surfaces 70 to inhibit the shutter 40 from being accidentally removed from the archwire slot 495. At the same time, the lingual surface of the locking shutter 40 contacts the archwire 50 to urge it continuously into the archwire slot 45. The shutter 40 can be closed using a finger by simply pushing on the shutter until the gingival end of the shutter enters the archwire slot 45 with the lingual surface in contact with the archwire 50. The locking shutter 40 can be opened by inserting a one or two prong ligature director into the aperture 65 and applying an occlusally directed force on the shutter in the interwing region—that is in the region between the occlusal tie wings. Alternative embodiments may include a guide bar or lingual guide bar used to position the locking shutter, or a slot beneath the bracket body through which a portion of the locking shutter extends.

The way in which the locking shutter maintains its position or is fixed onto the bracket body is not an essential feature of this invention, and any such means of attaching as is known in the prior art or which may be adapted in future use may be applied to this invention.

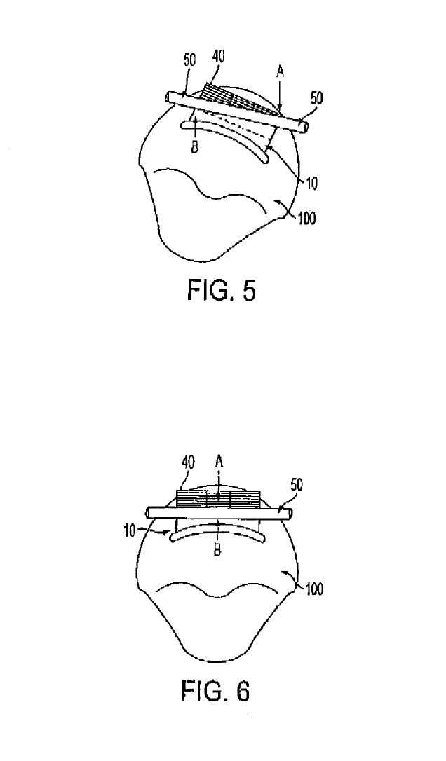

The design of the locking shutter 40 is such that an archwire 50 is seated to apply torque to the archwire slot 45 depending on the cross-sectional shape of the archwire 50. The continuous active seating or biasing of the archwire by the shutter 40 provides for accurate tooth movement. Referring now to FIGS. 5 and 6, a tooth 100 with an orthodontic bracket 10 on it is shown. In FIG. 5, the tooth 100 is shown in an original “rotated” (exaggerated for illustrative purposes) position while in FIG. 6, the tooth is shown in a final “straight” position. The designations A and B in denote coupled sets of force vectors applied by the shutter 40 on the orthodontic bracket and archwire. As can be seen, the archwire 50 in FIG. 5 deflects the shutter 40 labially on the right side reducing the initial force and moment applied to the tooth 40 until the shutter gradually seats itself appropriately as shown in FIG. 6 with less patient discomfort. As has been discovered, under certain conditions labial-lingual rotation of the bracket with respect to the archwire can be a hindrance to effective orthodontic treatment.

Accordingly, in order to offset the labial-lingual rotation of the bracket with respect to the archwire, the invention provides for an improved locking shutter 35 having a main portion 75 and an extension portion 80 effective as an archwire guide, whereby the extension portion 80 of the locking shutter 40 protrudes past the body 15 of the bracket 10 proximate the area of the archwire slot 45. Preferably, the extension portion 80 is provided on both the mesial 85 and distal 90 sides of the bracket. The extension portions 80 increase the linear contact area between the locking shutter 40 and the archwire 50, thereby working against the movement along the archwire 50 of the bracket that ultimately leads to undesired rotation of the bracket 10. The locking shutter 40 according to the invention can also readily be adapted to existing bracket bodies, or retrofitted onto same.

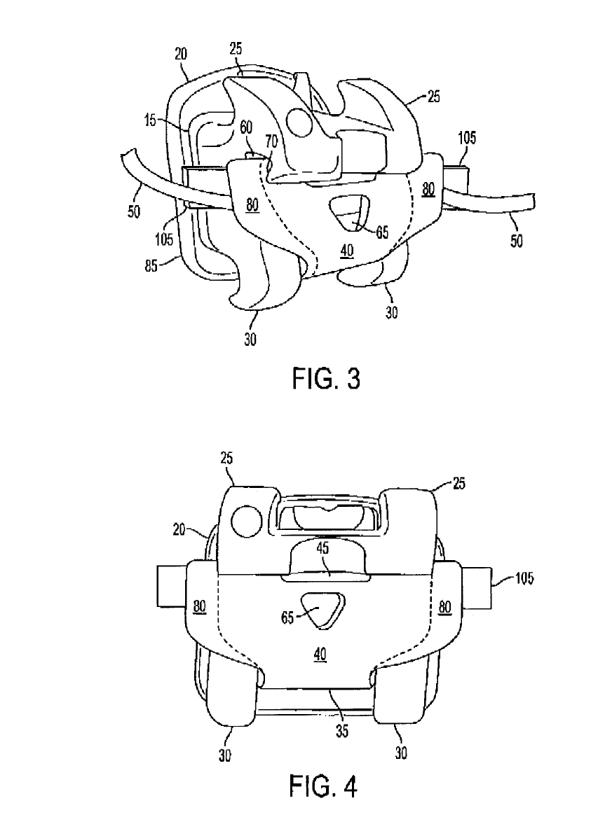

In the preferred embodiment, the extensions portions 80 extend generally parallel to the bracket body to a position beyond an outer edge 90 of the body 15, and then optionally curve towards the archwire slot 45, by curved portions 95. The embodiment including a curved portion is shown in FIGS. 1 and 2, whereas a straight extension portion is shown in FIGS. 3 and 4. Such a curvature may be provided to accommodate smaller wires and urge such smaller wires towards the base of the archwire slot 45. The curved portions 95 also provide additional support in maintaining the archwire 50 within the archwire slot 45. Preferably, the curved portions 95 include a radius of curvature large enough that the curved portions 95 are able to also initially seat smaller archwires within the archwire slot45 without the curvature causing any damage to the archwire during the treatment. The particular degree of curvature is not essential to the invention, except insofar as the curved portion is intended to bring an edge of the locking shutter into closer proximity with the archwire.

In addition, each of the the extension portion 80 and the curved portions 95 are typically formed integrally with the locking shutter 40. As illustrated in the drawings, the dashed line illustrates the boundary of the locking shutter in typical prior art implementations. it was heretofore thought that maintaining the locking shutter within the bracket body facilitated opening and closing of the locking shutter, however, this comes at the expense of the labial-lingual rotation as described above.

In another embodiment of the invention, the bracket 20 further includes an archwire guide 105 that extends beyond the bracket body 15, and preferably beyond the mesial and distal sides of the bonding base 20 as well. The archwire guide 105 may be formed integrally with the bracket body itself, or may be provided by way of an addition to the bracket body, for example by extending from the rear of the body or attached to a side portion of the body to effectively extend the bottom surface of the archwire slot, on which the archwire 50 rests beyond the bottom surface of the the archwire slot 495. The archwire guide 105 also provides an increase in the linear contact area between the bracket and the archwire 50 that aids in resisting rotation of the bracket. Optionally, the archwire guide may be formed from a flexible material (as shown in FIGS. 1 and 2), such as relatively thin stainless steel that permits the archwire guide 105 to be added, substituted or removed at various stages of the orthodontic treatment, and depending on the tension in the archwire. The practitioner administering treatment will be aware of a range of tension and sizes of the archwire that are more prone to rotation, and accordingly, the archwire guide can optionally only be employed when rotation is more likely. This effectively extends the useful life of the bracket and permits the bracket body to be used with a wider range of treatments. In practice, the archwire guide 105 functions to effectively increase the functionally length of the archwire slot without increasing the size of the bracket body. This has clear advantages in resisting any labial-lingual rotation of the bracket by decreasing the torque applied by the archwire onto the bracket body, while still maintaining the tension in the archwire.

The invention is not limited to the specific embodiments herein described, with functional alternatives and variations contemplated within the scope of the invention, which is limited only by the claims that follow.

1. An orthodontic bracket comprising
a body including a bonding base for attachment to a tooth, at least one gingival tie wing and at least one occlusal tie wing; said at least one gingival tie wing and said at least one occlusal tie wing projecting from a labial surface of said body;
an archwire slot extending mesiodistally across said body and between said at least one gingival and occlusal tie wings at opposed mesial and distal sides of said body to accommodate an archwire;
a locking shutter moveable between an open position in which placement and removal of said archwire is facilitated and a closed position in which placement and removal of said archwire is inhibited;
wherein said locking shutter includes a main shutter portion which substantially covers said archwire slot when said locking shutter is in said closed position and an extension member extending beyond an outer edge of said body to contact a portion of said archwire outside of said archwire slot.

2. The orthodontic bracket according to claim 1, wherein said at least one gingival tie wing comprises a pair of gingival tie wings, and said at least one occlusal tie wing comprises a pair of occlusal tie wings.

3. The orthodontic bracket according to claim 2, wherein said extension member projects beyond an outer edge of said body in a direction generally parallel with an underside of said bonding base.

4. The orthodontic bracket according to claim 3, wherein said extension member further includes a curved portion.

5. The orthodontic bracket according to claim 4, wherein said curved portion extends towards said archwire to thereby contact said archwire.

6. The orthodontic bracket according to claim 2, wherein said main shutter portion extends into a locking shutter slot formed on an underside a said pair of gingival tie wings.

7. The orthodontic bracket according to claim 1, further comprising an archwire guide adapted to support said archwire at a region distal from said archwire slot.

8. The orthodontic bracket according to claim 7, wherein said archwire guide forms an extension of a bottom surface of said archwire slot.

9. The orthodontic bracket according to claim 7, wherein said archwire guide is formed from a semi-rigid or flexible material.

10. The orthodontic bracket according to claim 7, wherein said archwire guide extends to a position beyond said an outer edge of said bonding base on one or both of said mesial and distal sides of the bracket.

11. An orthodontic bracket comprising
a body including a bonding base for attachment to a tooth, at least one gingival tie wing and at least one occlusal tie wing; said at least one gingival tie wing and said at least one occlusal tie wing projecting from a labial surface of said body;
an archwire slot extending mesiodistally across said body and between said at least one gingival and occlusal tie wings at opposed mesial and distal sides of said body to accommodate an archwire;
a locking shutter moveable between an open position in which placement and removal of said archwire is facilitated and a closed position in which placement and removal of said archwire is inhibited; and,
an archwire guide adapted to support said archwire at a region distal from said archwire slot.

12. The orthodontic bracket according to claim 11, wherein said archwire guide forms an extension of a bottom surface of said archwire slot.

13. The orthodontic bracket according to claim 11, wherein said archwire guide is formed from a semi-rigid or flexible material.

14. The orthodontic bracket according to claim 11, wherein said archwire guide extends to a position beyond said an outer edge of said bonding base on one or both of said mesial and distal sides of the bracket.

15. The orthodontic bracket according to claim 11, wherein said locking shutter includes a main shutter portion which substantially covers said archwire slot when said locking shutter is in said closed position and an extension member extending beyond an outer edge of said body to contact a portion of said archwire outside of said archwire slot.

16. The orthodontic bracket according to claim 15, wherein said at least one gingival tie wing comprises a pair of gingival tie wings, and said at least one occlusal tie wing comprises a pair of occlusal tie wings.

17. The orthodontic bracket according to claim 16, wherein said extension member projects beyond an outer edge of said body in a direction generally parallel with an underside of said bonding base.

18. The orthodontic bracket according to claim 17, wherein said extension member further includes a curved portion.

19. The orthodontic bracket according to claim 18, wherein said curved portion extends towards said archwire to thereby contact said archwire.

20. The orthodontic bracket according to claim 16, wherein said main shutter portion extends into a locking shutter slot formed on an underside of said pair of gingival tie wings.
